(19) United States
(12) Patent Application Publication
(10) Pub. No.: US 2019/0187399 A1
(43) Pub. Date: Jun. 20, 2019

(54) PORTABLE LENS ASSEMBLY

(71) Applicant: Carmel Antoinette Devening-Jolly, Clearwater, FL (US)

(72) Inventor: Carmel Antoinette Devening-Jolly, Clearwater, FL (US)

(21) Appl. No.: 16/213,549

(22) Filed: Dec. 7, 2018

Related U.S. Application Data
(60) Provisional application No. 62/595,863, filed on Dec. 7, 2017.

(51) Int. Cl. G02B 7/02; F21V 33/00; F21V 21/092; F21V 23/06

(52) U.S. Cl. CPC G02B 7/02; F21V 23/06; F21V 21/0925; F21V 33/00

(57) ABSTRACT

A lens assembly includes a housing with a perimeter member, the perimeter member defining an opening, a lens disposed within the housing, an outer edge of the lens being retained by the perimeter member within the housing, a lighting device disposed on one side of the housing within the perimeter member; and an attachment device disposed on one side of the perimeter member of the housing, the attachment device being configured to removably attach the housing to a target object.

### FIELD

The aspects of the disclosed embodiment generally to mirrors, and more particularly to a portable lens assembly for a make-up mirror that includes a prescription lens.

### BACKGROUND

For those that wear eyeglasses to assist their vision, it can be difficult to apply eye makeup while wearing the eyeglasses. In most instances, the eye glasses need to be removed, or otherwise they will get in the way of the application of the makeup. However, when an individual who requires eyeglasses for vision takes the eyeglasses off, their vision can be hindered or impaired. This can impede the ability to see clearly while applying makeup. Thus, for a person who normally wears or needs eyeglasses to see properly, not being able to wear eyeglasses during eye makeup application can pose certain challenges.

While the use of contact lenses may be a solution, not everyone wears contact lenses. Also, it is not unknown for eye irritation to occur due to makeup powders drying the eyes out.

In some instances a magnifying mirror can be used. However, there are a number of drawbacks to the use of a magnifying mirror, including for example, that the magnified image may not be crisp and clear. Further, eye strain can occur due to a warped image on the sides of mirror which could then lead to headaches and dizziness. It would be advantageous to provide a device that will enable an individual to be able to use a mirror, such as when applying makeup, without the need to wear glasses or use contact lenses, but still be able to see clearly and without strain.

Accordingly, it would be desirable to be able to provide a mirror device or assembly that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the exemplary embodiments relate to a lens assembly. In one embodiment, the lens assembly includes housing with a perimeter member, the perimeter member defining an opening; a lens disposed within the housing, an outer edge of the lens being retained by the perimeter member within the housing; a lighting device disposed on one side of the housing within the perimeter member; and an attachment device disposed on one side of the perimeter member of the housing, the attachment device being configured to removably attach the housing to a target object.

In one embodiment, the lens comprises a prescription lens.

In one embodiment, the lighting device is disposed in a user facing side of the housing.

In one embodiment, the attachment device comprises at least one suction cup disposed on a side of the perimeter member of the housing facing the target object.

In one embodiment, the at least one suction cup is configured to releasably engage a smooth surface of the target object and secure the lens assembly to the target object.

In one embodiment, the target object is a mirror.

In one embodiment, the target object is a display screen of an electronic device.

In one embodiment, there is an opening in an edge side of the housing, the opening being configured to receive the lens when the lens is inserted thereto.

In one embodiment, the lens assembly has a two-piece cover that is configured to be separated to allow access to components of the lens assembly, including removing and inserting the lens.

In one embodiment, a hinge connects the two portions of the two-piece cover and allows the lens assembly to be opened and closed.

In one embodiment, the lens can be removed and replaced when the two-piece cover is opened.

In one embodiment, the assembly includes a locking mechanism within the housing, the locking mechanism configured to retain the lens in a secure position within the housing after the lens is inserted into the opening.

In one embodiment, the assembly includes a switch disposed on a side edge of the housing, the switch being connected to the locking mechanism within the housing, wherein when the switch is activated, the locking mechanism is configured to release the lens and enable at least a portion of the lens to be ejected through the opening.

In one embodiment, after ejection of the lens through the opening, another lens is configured to be received in the opening and engage the locking mechanism to be secured within the housing.

In one embodiment, a diameter of an exposed portion of the lens within the opening defined by the perimeter member is approximately 10 inches.

In one embodiment, the assembly includes a control module disposed in a hollow region defined between two sides of then housing, the control module configured to provide power to the lighting device.

In one embodiment, the assembly includes a Universal Serial Bus (USB) connector connected to the control module, the USP connector configured to receive a USB power and control input.

In one embodiment, the assembly includes a first lighting control device on one side of the perimeter member, the first lighting control device connected to the control module and the lighting device, and configured to adjust power to the lighting device.

In one embodiment, the assembly includes a second lighting control device on the one side of the perimeter member, the second lighting control device connected to the control module and the lighting device and configured to adjust a type light provided by the lighting device.

In one embodiment, the lens comprises a prescription lens.

In one embodiment, the lens has any suitable shape, size, prescription strength.

In one embodiment, a clip can be used to attached the lens assembly to the object, such as a mirror, computer screen or book.

In one embodiment, the hangar, clip or clips of the lens assembly goes over a top edge of the object.

In one embodiment, the clip or clips of the lens assembly are attached to the sides of the object.

In one embodiment, the lens assembly can be attached to the object using any suitable means of adherence.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which:

FIG. 1 is a front view of an exemplary makeup mirror lens assembly incorporating aspects of the disclosed embodiments.

FIG. 2 is a back view of an exemplary makeup mirror lens assembly incorporating aspects of the disclosed embodiments.

FIG. 3 is a side view of an exemplary makeup mirror lens assembly incorporating aspects of the disclosed embodiments.

FIG. 4 is another side view of an exemplary makeup mirror lens assembly incorporating aspects of the disclosed embodiments.

FIG. 5 is a an exemplary application of a mirror lens assembly incorporating aspects of the disclosed embodiments.

FIG. 6 illustrates an exemplary application of a mirror lens assembly incorporating aspects of the disclosed embodiments.

FIG. 7 illustrates an exemplary application of a mirror lens assembly incorporating aspects of the disclosed embodiments in conjunction with an electronic device.

### DETAILED DESCRIPTION OF THE DISCLOSED EMBODIMENTS

The aspects of the disclosed embodiments are directed to a lens assembly for a mirror, and in particular, a lens assembly for a makeup mirror. The lens assembly is configured to be attached to an outer surface or lens of a mirror and will provide the user with clear or clearer vision through the lens assembly and mirror. The lens assembly can be customized to a user's specific vision requirements, such as eyeglass prescription requirements. While the aspects of the disclosed embodiments will generally be described herein with respect to a makeup mirror, the aspects of the disclosed embodiments are not so limited. In alternate embodiments, the lens assembly can be used in conjunction with any device or article where crisp and clear viewing is desired.

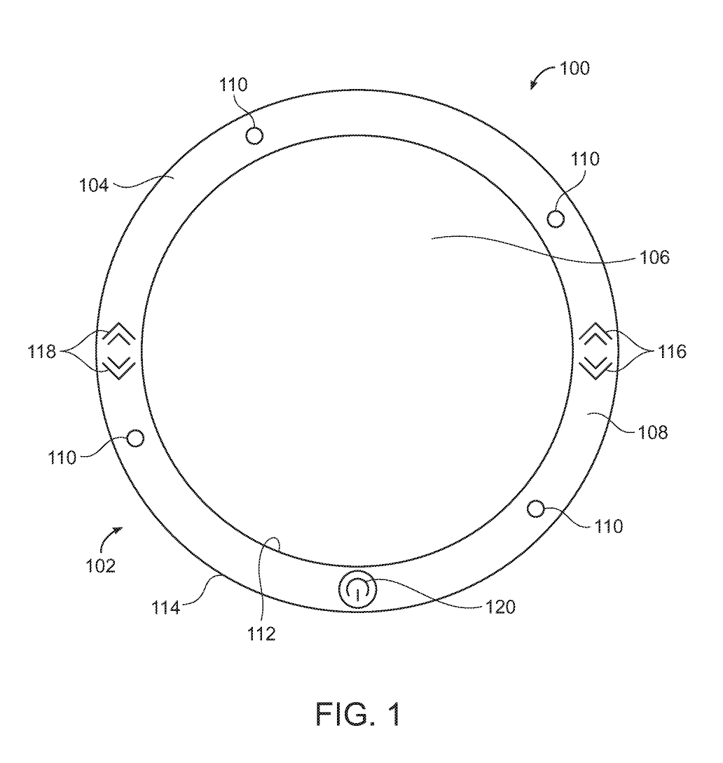

Referring to FIG. 1, one example of a mirror lens assembly 100 incorporating aspects of the disclosed embodiments is illustrated. FIG. 1 generally illustrates the front or user facing side 102 of the mirror assembly 100. The front side 102 of the mirror assembly 100 is the side of the mirror assembly 100 that a user will typically be looking at or facing. The mirror or device being viewed will be disposed behind the mirror assembly 100.

In the embodiment illustrated in FIG. 1, the mirror lens assembly 100 includes a housing or housing assembly 104 and a lens 106. In the example of FIG. 1, the lens 106 is retained in place within or by the housing assembly 104. The housing assembly 104 may also be referred to as a rim assembly. The housing assembly 104 is generally a rigid or semi-rigid structure that is configured to protect and support the lens 106. Materials can include, but are not limited to, plastic for example.

The housing 104 is generally configured to secure the lens or lens assembly 106 within the mirror lens assembly 100. In the example of FIG. 1, an edge region or portion 108 of the housing assembly 104 encloses or covers a corresponding portion of the lens 106. Generally, the corresponding portion of the lens 106 covered by the edge portion 108 of the housing assembly 104 will be or form a perimeter area of the lens 106. The edge portion 108, also referred to as a rim assembly, generally extends around the perimeter of the lens 106. The edge portion 108 can partially or fully enclose the perimeter of the lens 106. In one embodiment, the edge portion 108 is made of a plastic material. In alternate embodiments, the edge or rim portion 108 can comprise any suitable material other than including plastic. The aspects of the disclosed embodiments are not intended to be limited by the particular type of material for the housing and rim.

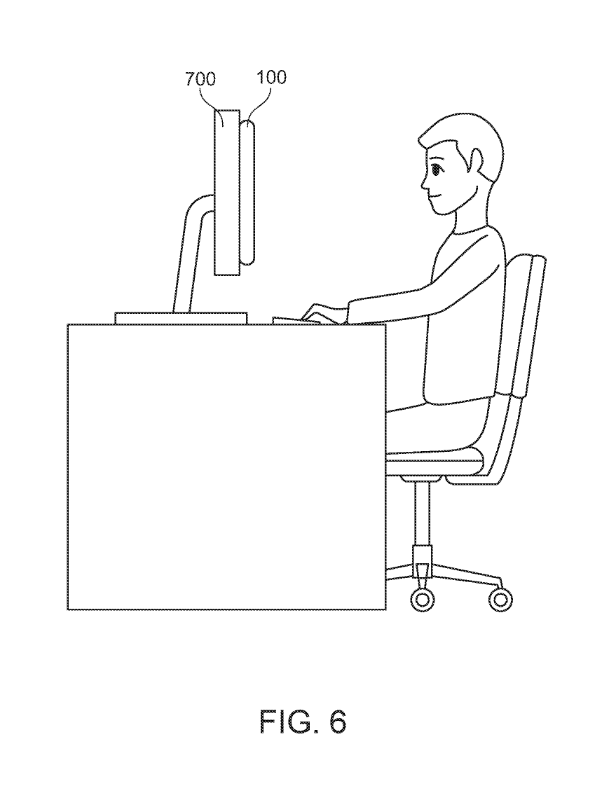

In one embodiment, the edge portion 108 of the housing assembly 104 is configured to provide illumination to the mirror lens assembly 100. For example, the edge portion 108 of the housing assembly 104 can include one or more lighting devices 110. In one embodiment, the main function of the lighting devices or lights 110 is to illuminate the face of the user, when the user is looking through the lens assembly 100 and into a mirror, such as shown in the example of FIG. 6. This allows the user to tend to any facial details necessary, makeup applications and contact lens applications, for example.

In one embodiment, the lighting devices 110 comprise light emitting diode devices. In alternate embodiments any suitable lighting device can be used that will provide suitable illumination in a small form factor. In one embodiment, the housing assembly 104 can include or be coupled to a suitable power source or controller for powering the lighting devices 110.

Although four lighting devices 110 are illustrated in the example of FIG. 1, the aspects of the disclosed embodiments are not so limited. In alternate embodiments any suitable number of lighting devices 110 can be included, other than including four. For example, in one embodiment, the lighting device 110 can comprise one or more lighting strips, such as an LED strip. The LED strip can be disposed along the edge portion 108 in any suitable manner, such as in a continuous strip that extends along the rim portion 108.

In one embodiment, the lighting devices 110 are disposed within the area between a first or inner edge 112 and a second or outer edge 114 of the edge portion 108 of the housing assembly 104. The width of the illuminated edge portion 108 can be any suitable width, depending upon the application. The lighting devices 110 can be configured to illuminate an object in front of the mirror lens assembly 100, such as the user's face shown in FIG. 6, when, for example, applying makeup or performing other similar actions. Alternatively, the lighting devices 110 can be configured to illuminate a target object that is being viewed with the mirror lens assembly 100.

In one embodiment, the lighting device(s) 110 can disposed along the inner edge 112 of the edge portion 108. For example, the inner edge 112 may have a height associated with it, above the lens 106, which will provide for one or more lighting devices 110 to be disposed. In this example, the lighting devices 110 can be directed to or aimed to illuminate inwards towards a central region of the lens 106. The lighting devices 110 can also be aimed towards or directed to a rear or back of the mirror lens assembly 100. In this manner, the lighting device(s) 110 can be used to illuminate the equipment or article, such as a book or magazine, over which the mirror lens assembly 100 is disposed. For example, the lighting devices 110 can be disposed on the other or back side of the edge portion 108 of the housing assembly 102, depending upon the target object to be illuminated.

In one embodiment, the front side 102 of the housing assembly 104 can include one or more controls, generally shown as control(s) 116 and control(s) 118. In one embodiment, control(s) 116 can be configured to power and control the lighting devices 110. For example, control(s) 116 can be used to power on the lighting devices 110. If the lighting devices 110 are dimmable, the control(s) 116 can be used to intensify and dim the lighting device(s) 110, for example using up or down control switching devices or a single device.

The control or controls 116 can include one or more control devices or switches, depending upon the particular application. For example, if there is only a single lighting device 110, a single switch or control 116 can be used to power the lighting device 110 on and off. Alternatively, the control 116 can comprise more than one switch or a multi-position switch. For example, control 116 can include an increase lighting intensity position or mode and a decrease lighting intensity position or mode. In this example, the control 116 could also include a separate on/off switch, in addition to the increase/decrease intensity controls.

In one embodiment, the lighting devices 110 can include adjustable brightness as well as adjustable warm/cool lighting variations. In this example, the control(s) 116 can be used to power the lighting devices 110 in the edge portion 108 on and off, as well as adjust the brightness and any warm/cool variations. Alternatively, control or switch 118 could be used to provide one or more of the above functions. The controls 116 and 118 can be any suitable switch or switches that can be used in an lighting or LED power circuit. Examples can include, but are not limited to push button, rocker, touchtone or touch sensitive switches, buttons or controls. The controls 116 and 118 can also include dimmable types of switches, where such application is desired. The dimmer switch can be any suitable type of dimmer switch, including a mechanical switch with up and down buttons, or an electronic, touch sensitive switch. In one embodiment, one or more of the controls 116, 118 can be a wireless control device. In this example, one or more of the controls 116, 118 can be controlled by a mobile communication or computing device, using for example, Bluetooth™ communication. This can enable more variation in lighting types and effects as the different switching and lighting options can be part of the mobile device. The aspects of the disclosed embodiments are not intended to be limited by the particular type of controls or switch that is used.

In one embodiment, the mirror lens assembly 100 can include a colour adjustment control or switch. For example, one or more of controls 116 and 118 can be used to adjust the color of the lighting provided by the lighting devices 110 in the edge portion 108, such as cool or warm. For example, LEDs used in the illuminated edge portion 108 can be configured to provide different shades and colors depending on the state of the LEDs.

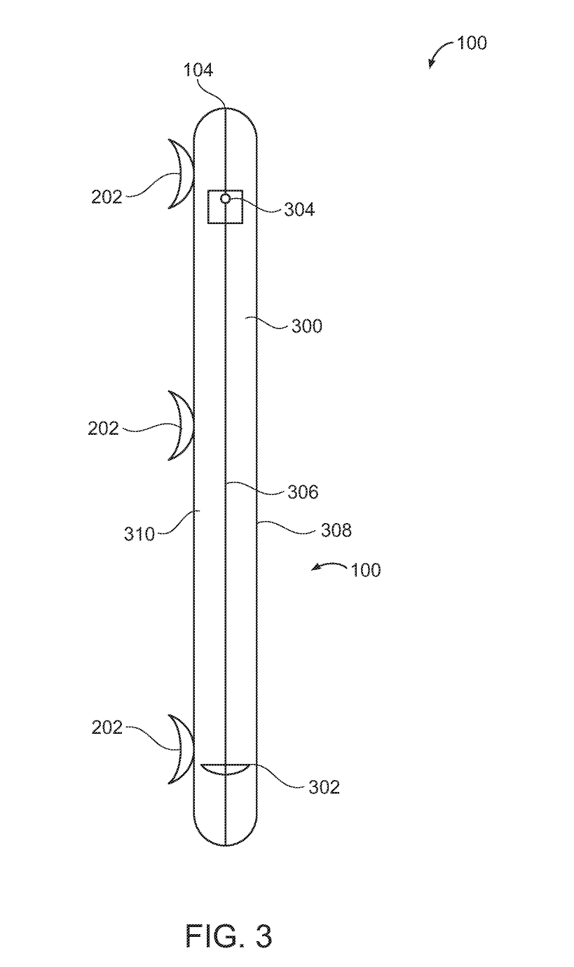

In one embodiment, power for the lighting devices 110 in the mirror lens assembly 100 can be provided by batteries (DC circuit) or house power (AC circuit). Alternatively, power for the lights can be provided over a Universal Serial Bus (USB) connection. Referring to FIG. 3, in one embodiment, the mirror lens assembly 100 can include a suitable port 302 for the power connection, such as a USB port, for example. The USB port 302 and connection can be used to power the lights as well as recharge any batteries that are housed within the housing 104 of the mirror lens assembly 100. The port 302 can also be used to receive the control signals for operating an lighting devices in or part of the assembly 100.

In the example of FIG. 3, the USB port 302 is shown as disposed along or in the side of housing 104 of the mirror lens assembly 100. In alternate embodiments, the power or USB 302 can be disposed on or along any suitable portion of the housing 104 of the mirror lens assembly 100, such as for example, the back. While only one USB port 302 is shown in FIG. 3, the aspects of the disclosed embodiments are not so limited. In alternate embodiments, the mirror lens assembly 100 can include any suitable number of USB ports 302, or other charging or power ports. For example, in one embodiment, the port 302 can be configured to receive or connect to an AC power supply or a DC power supply. In one embodiment, an AC or DC power cord is suitably coupled or connected to the control circuitry and lighting devices 110.

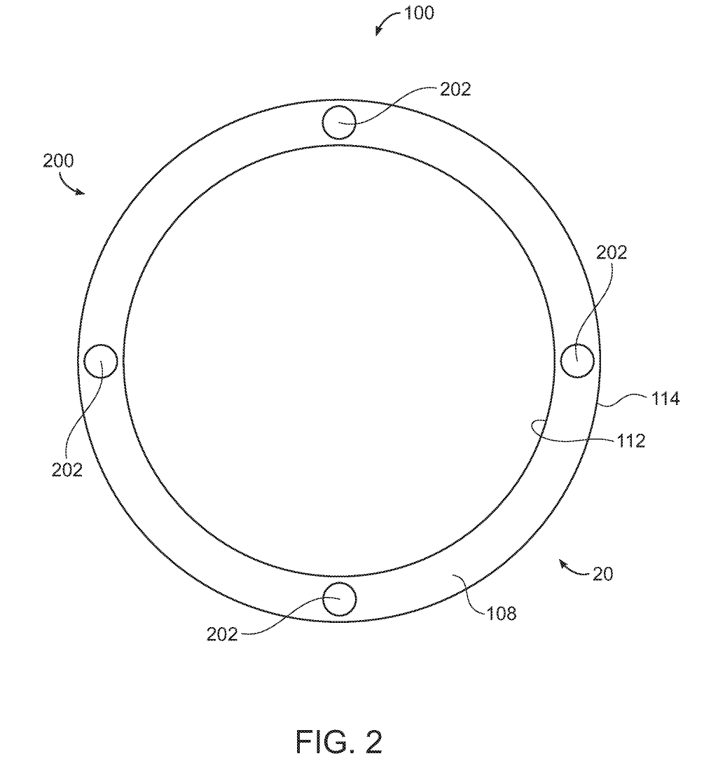

FIG. 2 illustrates one embodiment of a back side 200 of an exemplary mirror lens assembly 100 incorporating aspects of the disclosed embodiments. In this example, the back side 200 of the mirror lens assembly 100 includes one or more attachment devices 202. The attachment devices 202 are configured to enable the mirror lens assembly to be removably attached or mounted to the target object, such as for example, a makeup mirror.

In one embodiment, the attachment devices 202 are suction cup type devices. The suction cup devices are configured to adhere to the glass of a target object, such as a mirror. Referring also to FIG. 3, the suction cups 202 on the back side 310 of the housing unit 104 will allow the portability of adhering the lens assembly 100 to any mirror or smooth surface. In alternate embodiments, any suitable attachment device can be used that will allow the lens assembly 100 to be removably attached to a target object such as a mirror or display of an electronic device in a secure fashion. Examples include, but are not limited to, clips that secure the two parts together, magnetic devices or the use of loop and hook fastener devices.

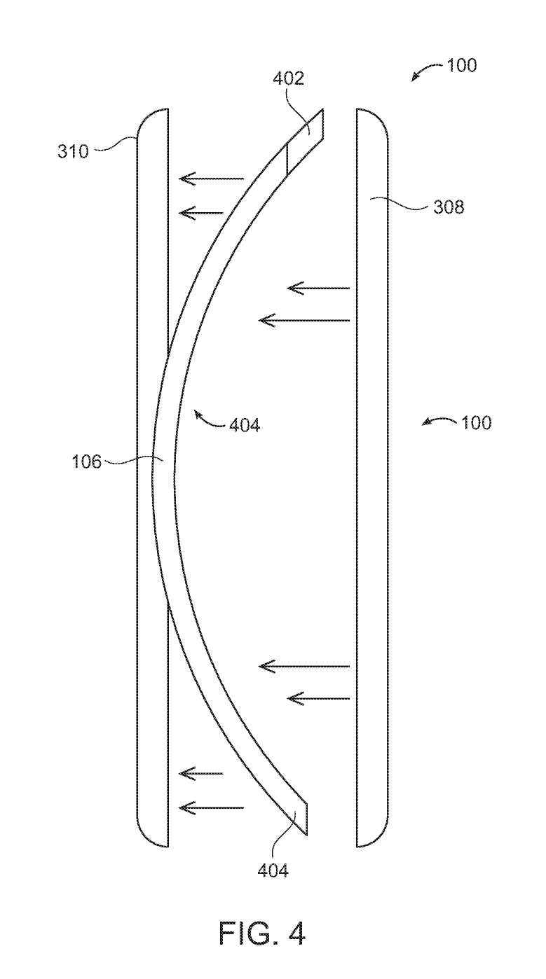

FIGS. 3 and 4 illustrate side views of one embodiment of the mirror lens assembly 100. In the example of FIG. 3, one side 300 of the lens assembly 100 can include a main power switch 304. This switch 304 can be any suitable switch and can be in addition to, or replace, the controls 116 and 118 illustrated in FIG. 1.

While controls 116 and 118 are illustrated on the front surface of the housing 104, the aspects of the disclosed embodiments are not so limited. In alternate embodiments, one or more of the controls 116 and 118 could be disposed on a side 300 of the housing 104 of the mirror lens assembly.

In one embodiment, the housing 104 for the lens assembly 100 is a two-piece housing. In the example of FIG. 3, the line 306 illustrates where the two members or sides 308, 310 of the housing 104 come together. In this example, side 308 can be referred to as a front side member 308, while side 310 can be referred to as a back side member 310. In one embodiment, the interface 306 between the two members or side 308, 310 can be seamless. This is especially true where the housing 104 is of a one-piece or unitary construction and the housing 104 does not comprise two separate and distinct members.

In one embodiment, the interior of the housing 104 is substantially open or includes one or more hollow areas or regions. The open areas or hollow regions can generally be configured to allow hardware of the lighting device(s) 110 to be disposed therein and between and by the two members or sides 308, 310 of the housing 104. For example, the wiring, connectors, control circuitry, printed circuit boards, lighting devices or components, audio devices and other electronics or hardware can be disposed within the hollow or open areas that are formed by and between the two members 308, 310 of the housing 104.

As is illustrated in FIG. 4, the lens 106 is configured to be retained within the housing assembly 104, between the front side member 308 and the back side member 310. FIG. 4 illustrates how the lens 106 can be disposed between the front and back side members 308, 310 of the housing 104. As described above the perimeter edge or region 402 of the lens 106 shown in FIG. 4 is retained in the edge portion 108, between the front side member 308 and the back side member 310. The interior depth of each member 308, 310 and the space formed between the members 308, 310 in the connected state, will be configured to accommodate any suitably sized and curved lens 106. The dimension of the perimeter edge or region 402 is any suitable dimension that enables the lens 106 to be suitably and securely retained within the housing assembly 104.

The lens 106 can be any suitable lens that enhances the viewing experience for the user. In one embodiment, the lens or lens assembly 106 of the disclosed embodiments can be crafted by the same manufacturers that make eyeglasses. The lens 106 can be a customizable prescription lens. The aspects of the disclosed embodiments are directed to allowing the user to see with the same clarity as eye wear, while using the lens assembly 100. Since the prescription is the same, this will allow for a smooth transition to using the lens assembly when not wearing eyeglasses, which can result in less headaches, dizziness and eye strain, for example, which might otherwise occur when a user is squinting or straining to see features clearly and distinctly.

The aspects of the disclosed embodiments provide for any suitably sized and shaped lens 106 to be used. For example, in one embodiment, the diameter of the lens 106 can be approximately 10 inches. With a 10 inch lens 106, the user can truly get the experience of self-grooming in the mirror without having to focus on one tiny area at a time. Although a 10 inch lens is referred to herein, the aspects of the disclosed embodiments are not so limited. In alternate embodiment, the diameter of the lens 106 can be any suitable size, other than including 10 inches. For example, the diameter might be less than 10 inches, such as in the range of approximately 2 to and including 8 inches. Alternatively the lens 106 could have a diameter of greater than approximately 10 inches.

In the example of FIG. 4, the shape of the lens 106 is substantially circular or round. However, the shape of the lens 106 can be any suitable shape, such as square, rectangular, oval or oblong, for example. The housing assembly 104 is suitably designed to accommodate any sized and shaped lens 106.

In the example of FIG. 4, the profile 404 of the lens 106 has a curved shape or profile, such as according to a prescription. As the housing parts 308, 310 are assembled together, this curvature 404 can help in securing the lens 106 in place. In alternate embodiments, the lens 106 does not need to be curved, and the lens 106 can have any suitable profile.

In one embodiment, the lens 106 comprises a prescription lens and will have optical properties similar to those realized in prescription glasses. The lens 106 is generally configured to be adapted to any suitable prescription or viewing requirement in a manner as is generally understood. For example, the lens 106 can be configured to be specific to the user's particular vision requirements, such as 20-100, 20-200, for example. The lens 106 of the lens assembly 100 is generally configured to provide a custom reflection that substantially duplicates the user's prescription eyewear. In this manner, since the optical properties of the lens 106 will be configured to substantially match the prescription of the user's eyeglasses, the image the user sees when looking in the lens assembly 100, without their glasses on, will be substantially the same as what the user would see if they had their glasses on. In this manner, the image or reflection the user sees in the mirror will be generally clear and crisp.

The lens assembly 100 in this example is generally round in shape, although the aspects of the disclosed embodiments are not so limited and can include any suitable shape and style. For example, the lens assembly 100 can be oval, square or rectangular, for example. Other shapes can be contemplated as well, such as a star or heart. The aspects of the disclosed embodiments are not intended to be limited by the particular shape, size, prescription strength or use of the lens assembly 100.

The lens 106 of the disclosed embodiments can be made of, but not limited to, a lightweight acrylic material that is easily portable and shatterproof as well. The lens 106 can also have a scratch resistant coating that ensures durability and easy cleaning. Although an acrylic material is described herein, the material of the lens 106 can be any suitable lens material. The material of the lens 106 is configured to be lightweight and shatterproof, and enable traveling with the lens assembly 100 simple and easy.

In one embodiment, the lens 106 is configured to be removed and replaced in the housing assembly 106. The aspects of the disclosed embodiments are configured to provide for interoperability and interchangeability of different lens 106. As an example, the housing 106 can have a push button or similar device that will release or eject the lens 106 from housing. In this manner, one lens 106 can be removed and replaced with a different lens 106. This allows the user to switch out one lens for another once their personal prescription has changed, without the need to replace the housing 106 or obtain a new lens assembly 100. Alternatively, the two housing portions 308, 310 can be configured to be separated to allow one lens 106 to be removed and another lens 106 to be inserted.

The manner of connection the housing portions 308, 310 in this example can be any suitable manner that allows for ease of operability and opening and closing. For example, in one embodiment, the housing portions 308, 310 can be connected together with one or more snap-fit type connections. Alternatively, screws or other fasteners can be used. In one embodiment, a hinge member can be used to connect the housing portions 308, 310 together, with another catch or clasp to secure the two portions together. When the catch is opened, the portions 308, 310 can be separated, but still connected by the hinge. In one embodiment, a gasket member can be disposed between the portions 308, 310 to protect from environmental contamination when in the closed position.

The lens 106 generally comprises a large, optical prescription strength lens that can be attached to almost any mirror. While the aspects of the disclosed embodiments are generally described with respect to a mirror, the aspects of the disclosed embodiments are not so limited. Other applications of the disclosed embodiments can include, but are not limited to, a computer screen/tablet, books, and magazines. For instance, mirror assembly 100 can be placed over or near something to be read. In an alternate embodiment, by removing the lens 106 from housing 104 and placing the lens 106 directly over any reading material, such as a magazine, user can then hold magazine with lens at appropriate distance, and enjoy an eyeglass free experience. The custom prescription strength of the lens 106 in the lens assembly 100 will allow the user to perform tasks without eyeglasses, which would otherwise obstruct ease to perform certain tasks such as (but not limited to): applying makeup, facial grooming, contact lens application and removal, reading, etc.

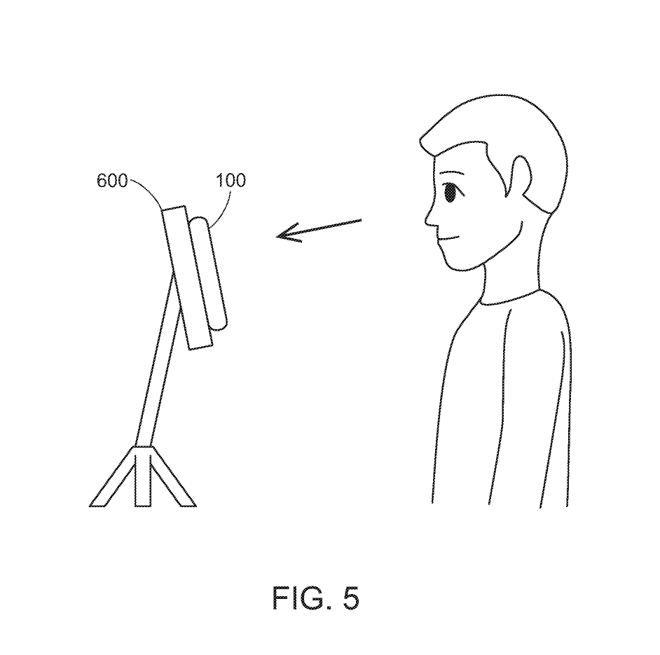

Referring to FIG. 5, in one application, the mirror lens assembly 100 is configured to be disposed in front of or over the reflective surface a mirror 600. In use, a user will look at or towards the mirror 600 through the lens 106 of the lens assembly 100. In this example, the lens assembly 100 is removably attached to the mirror 600.

FIG. 6 illustrates an exemplary application where the lens assembly 100 is used in conjunction with an electronic device 700, such as a computer. The lens assembly 100 in this example is shown removably attached to the screen or display of the computer.

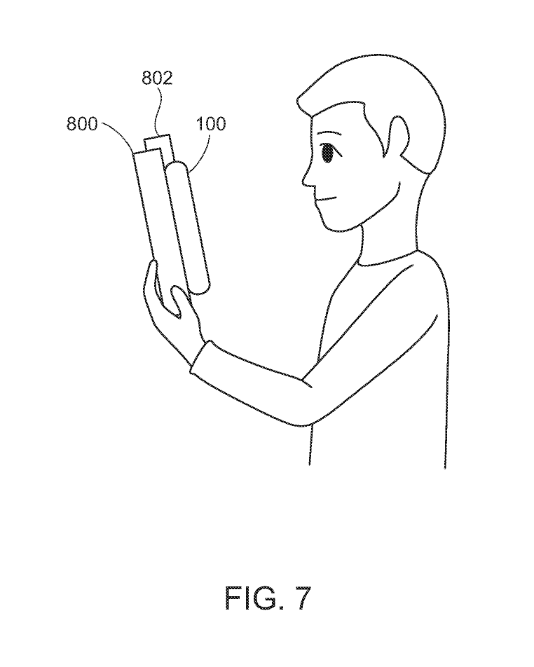

FIG. 7 illustrates an example where the lens assembly 100 is used in conjunction with an object 800 to be read, such as a book or a magazine. In this example, the lens assembly 100 can be held by hand over the object to be read. Also, in this example, the lighting device 110 of the lens assembly 100 can be disposed so as to provide light towards the object or material to be read. In this example, a clip 802 at the top of the assembly 100 can be used to hang the lens assembly 100 over one or more pages of the book 800. Although the clip or attachment device 802 is shown at the top in this example, in one embodiment, the attachment device 802 could also be at one or more of the sides of the book 802.

The lens assembly 100 of the disclosed embodiments provides several advantages. These can include for example, but are not limited to, eliminating headaches and eye strain due to blurriness. The user will also have an easier time performing tasks when looking in a mirror through the lens assembly 100 of the disclosed embodiment, when for example, applying make-up, or reading without wearing eyeglasses/contacts, which will aid in multiple daily uses.

The lens assembly 100 of the disclosed embodiment can be used in daily activities such as facial grooming, makeup application, contact lens application, reading books, magazines tablets, and more. For example when a woman who relies on eyeglasses for correct vision attempts to apply any makeup around the eye, she must take off her eyeglasses to gain access to her face, but then jeopardizes her vision due to lack of eyeglasses. Thus, she cannot apply eye makeup with her eyeglasses on because they would be in the way, and she also cannot apply makeup without her eyeglasses because then she cannot see clearly. With this predicament, she would then take the customized prescription lens assembly 100 of the disclosed embodiments and adhere it to any mirror of her preference. Then she can take her eyeglasses off and look into the mirror through the lens assembly 100 and successfully see herself with clear vision. The user can then proceed to apply makeup and groom themselves, for example.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those element, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice.

What is claimed is:

1. A lens assembly, comprising:
a housing with a perimeter member, the perimeter member defining an opening;
a lens disposed within the housing, an outer edge of the lens being retained by the perimeter member within the housing;
a lighting device disposed on one side of the housing within the perimeter member; and
an attachment device disposed on one side of the perimeter member of the housing, the attachment device being configured to removably attach the housing to a target object.

2. The lens assembly according to claim 1, wherein the lens comprises a prescription lens.

3. The lens assembly according to claim 1, wherein the lighting device is disposed in a user facing side of the housing.

4. The lens assembly according to claim 3, wherein the attachment device comprises at least one suction cup disposed on a side of the perimeter member of the housing facing the target object.

5. The lens assembly according to claim 4, wherein the at least one suction cup is configured to releasably engage a smooth surface of the target object and secure the lens assembly to the target object.

6. The lens assembly according to claim 5, wherein the target object is a mirror.

7. The lens assembly according to claim 5, wherein the target object is a display screen of an electronic device.

8. The lens assembly according to claim 1 further comprising an opening in an edge side of the housing, the opening being configured to receive the lens when the lens is inserted thereto.

9. The lens assembly according to claim 8, further comprising a locking mechanism within the housing, the locking mechanism configured to retain the lens in a secure position within the housing after the lens is inserted into the opening.

10. The lens assembly according to claim 9 further comprising a switch disposed on a side edge of the housing, the switch being connected to the locking mechanism within the housing, wherein when the switch is activated, the locking mechanism is configured to release the lens and enable at least a portion of the lens to be ejected through the opening.

11. The lens assembly according to claim 10, wherein after ejection of the lens through the opening, another lens is configured to be received in the opening and engage the locking mechanism to be secured within the housing.

12. The lens assembly according to claim 1, wherein a diameter of an exposed portion of the lens within the opening defined by the perimeter member is approximately 10 inches.

13. The lens assembly according to claim 1, comprising a control module disposed in a hollow region defined between two sides of then housing, the control module configured to provide power to the lighting device.

14. The lens assembly according to claim 13, comprising a Universal Serial Bus (USB) connector connected to the control module, the USP connector configured to receive a USB power and control input.

15. The lens assembly according to claim 14 further comprising a first lighting control device on one side of the perimeter member, the first lighting control device connected to the control module and the lighting device, and configured to adjust power to the lighting device.

16. The lens assembly according to claim 15 further comprising a second lighting control device on the one side of the perimeter member, the second lighting control device connected to the control module and the lighting device and configured to adjust a type light provided by the lighting device.

17. The lens assembly according to claim 1, wherein the lens comprises a prescription lens.
